(19) United States
(12) Patent Application Publication
(10) Pub. No.: US 2025/0158908 A1
(43) Pub. Date: May 15, 2025

(54) Flow Telemetry Triggered by Dropped Packets

(71) Applicant: Arista Networks, Inc., Santa Clara, CA (US)

(72) Inventors: Sahil MIDHA, Panchkula (IN); Padmanabh RATNAKAR, Bengaluru (IN)

(21) Appl. No.: 18/509,185

(22) Filed: Nov. 14, 2023

(51) Int. Cl. H04L 43/0829; H04L 43/022

(52) U.S. Cl. CPC H04L 43/0829; H04L 43/022

(57) ABSTRACT

A flow that experiences packet drops is targeted for explicit sampling based on a dropped packet. A sample policy is created that matches on the dropped packet; for example, the match criteria can be based on the 5-tuple of the dropped packet. The sample policy is programmed in the network device that dropped the packet. The sample policy is distributed to and programmed in network devices that are upstream and downstream of the dropping device. Packets in the flow can then be explicitly sampled to capture the flow as it passes through the network. The sample policy can be updated to remove rules directed to flows that had exhibited drops but have not experienced subsequent drops after a user-configurable period of time.

### BACKGROUND

Telemetry techniques such as Inband and Postcard Telemetry involve sampling packets along their forwarding paths. Typically, a network device that is configured to provide telemetry data randomly samples the packets that pass through the device. For example, with Postcard Telemetry, the sampling may be based on a TCP/UDP checksum contained in the header of the packet. When the checksum in a packet matches a pre-programmed value, the packet is sampled and transmitted to a collector. If the checksum is a 16-bit value, for example, the sample rate is approximately 1 in 2¹⁶ packets. It can be appreciated that random sampling does not target packets based on flows. As such, it can happen that flows experiencing drops are not sampled.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1A illustrates packet telemetry in a deployment in accordance with some embodiments of the present disclosure.

FIG. 1B shows a format of a Postcard packet in accordance with some embodiments.

FIG. 2 is a high-level block diagram of a network device in accordance with some embodiments of the present disclosure.

FIG. 3 a high-level block diagram of additional details in a network device in accordance with some embodiments of the present disclosure.

FIG. 4 shows a flow of operations in a network device in accordance with some embodiments of the present disclosure.

FIG. 5 illustrates an example of conventional processing of Postcard Telemetry.

FIG. 6 illustrates an example of processing of Postcard Telemetry in accordance with some embodiments of the present disclosure.

FIG. 7A illustrates a format of a flow database in the collector in accordance with some embodiments.

FIG. 7B represents a snapshot of the example of the flow record for Flow 1 shown in FIG. 6.

### DETAILED DESCRIPTION

The present disclosure is directed to using telemetry techniques to track flows that experience dropped packets. A known telemetry mechanism called Postcard-Based Telemetry or Postcard Telemetry (Postcard) will be used as the example throughout the present disclosure. It will be understood, however, that any suitable telemetry mechanisms can be adapted in accordance with the present disclosure; for example, Inband Flow Analyzer, Inband Network Telemetry.

A “flow” refers to the stream or sequence of packets between a source of the packets and a destination of the packets. More generally, a flow can refer to the bidirectional traffic between two nodes, A and B, where A and B are source and destination nodes (respectively) in one direction and destination and source nodes (respectively) in the other direction. For Transmission Control Protocol (TCP), a flow can be identified by the 5-tuple in the packet header of the packets in the flow, namely, the source and destination Internet protocol (IP) address, the source and destination ports, and the protocol type. Every packet in a given flow will have the same 5-tuple.

Postcard Telemetry can be configured with a sample policy to specify which flows to sample and report. Postcard Telemetry typically samples packets irrespective of which flow they belong to. For example, the user can introduce matching criteria (“sample policy”) comprising criteria such as, but not limited to, source prefix/destination prefix, etc. Only packets that match the sample policy will be subject to sampling. The user can specify to sample all packets matched by the sample policy. Alternatively, the user can specify to randomly sample some of the packets that match the sample policy; for example, based on checksum matching as noted above. Random sampling can be based on the TCP/UDP checksum (a 16-bit value) in the packet header. For example, in order to sample packets at a rate of one sample every 64K packets, the match criteria can include a rule that matches on a checksum equal to a value between 0-64K (e.g., 0x2000). Packets whose checksums are equal to 0x2000 would be sampled.

When one or more packets in a flow are dropped, the occurrence can be logged. In accordance with the present disclosure, the occurrence of a dropped packet can serve to trigger generating a sampling policy comprising a rule that matches on parameters that identify the flow (“targeted flow”) that experienced the dropped packet, for example, the dropped packet's 5-tuple. The sampling policy can be shared with other network devices (nodes) in the network. Packets matched by the network devices can be reported, for example, to a collector. Receiving packets that constitute the targeted flow from all the nodes in the flow path can give the collector a better understanding of the traffic traversing the network.

In the following description, for purposes of explanation, numerous examples and specific details are set forth in order to provide a thorough understanding of embodiments of the present disclosure. Particular embodiments as expressed in the claims may include some or all of the features in these examples, alone or in combination with other features described below, and may further include modifications and equivalents of the features and concepts described herein.

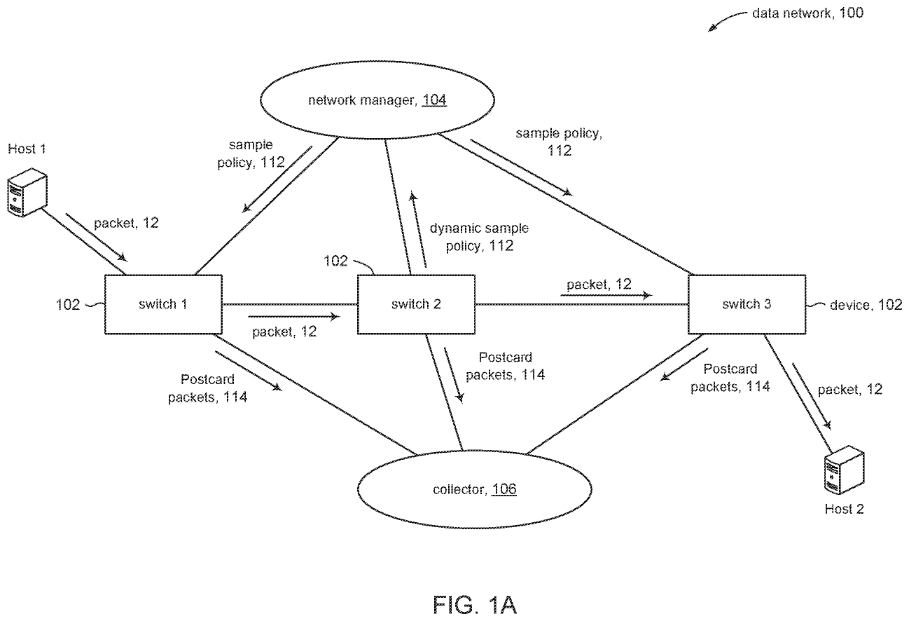

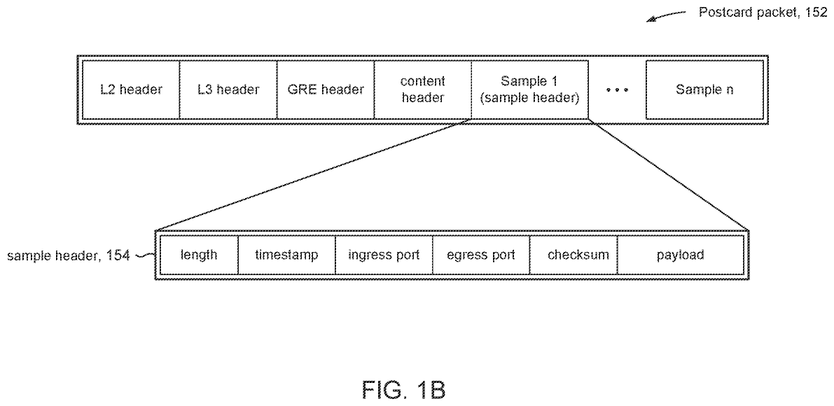

FIG. 1A is a high-level diagram illustrating an example data network 100 that can embody the techniques in accordance with the present disclosure. The network 100 can include network devices 102 for carrying traffic comprising packets 12 between host machines (e.g., Host 1 and Host 2) connected to the network 100.

A network manager 104 can configure, monitor, and otherwise manage network devices 102. An example of a production network controller is the CloudVision® network management platform developed and sold/licensed by Arista Networks, Inc. of Santa Clara, California; although it will be understood that embodiments in accordance with the present disclosure can employ other network controllers.

The data network 100 can be configured for Postcard Telemetry. It will be understood that any suitable telemetry framework can be used. For discussion purposes, however, the Postcard Telemetry framework will be used as an example. In some embodiments, for example, network devices 102 can be configured to produce Postcard Telemetry. Briefly, with Postcard Telemetry, each network device can be configured to sample packets in accordance with a sample policy (e.g., comprising one or more sampling rules). The network device generates and transmits Postcard packets 114 (telemetry), comprising one or more sampled packets matched by the sample policy, to a collector 106. The collector can analyze traffic flows among the network devices using the received Postcard Telemetry. Although FIG. 1A shows a single collector 106, it will be appreciated that the sampled packets can be transmitted to multiple collectors.

Referring for a moment to FIG. 1B, a brief description of the structure of a Postcard packet in accordance with some embodiments will be given. In some embodiments, for example, Postcard packet 152 can comprise various headers, including: a Layer 2 header, a Layer 3 header, a Generic Routing Encapsulation (GRE) header, a content header, and one or more sample headers 154 (Sample 1 to Sample n). Although not shown in FIG. 1B, the content header includes a count data field that represents the number of sample headers contained in the Postcard packet 152. Each sample header 154 corresponds to a sampled data packet. A sample header 154 can include data fields such as:
length—this refers to the length (e.g., bytes) of the data from the sampled packet
timestamp—this represents the time when the packet was sampled
ingress/egress port—these refer to the ports where the sampled packet entered and left the network device
payload checksum—this is a checksum of the data from the sampled packet
payload—this is the data from the sampled packet

In accordance with the present disclosure, a network device can dynamically generate Postcard sample policies in response to the network device detecting dropped packets. The generated sample policies can be distributed to and programmed in other Postcard Telemetry-enabled network devices. FIG. 1A, for example, shows switch 2 generating a sample policy 112 (in response to switch 2 dropping a packet) that is then distributed by network manager 104 to switches 1 and 3. Packets matched by the sample policy can then be transmitted in Postcard packets 114 to collector 106. These aspects of the present disclosure are described in more detail below

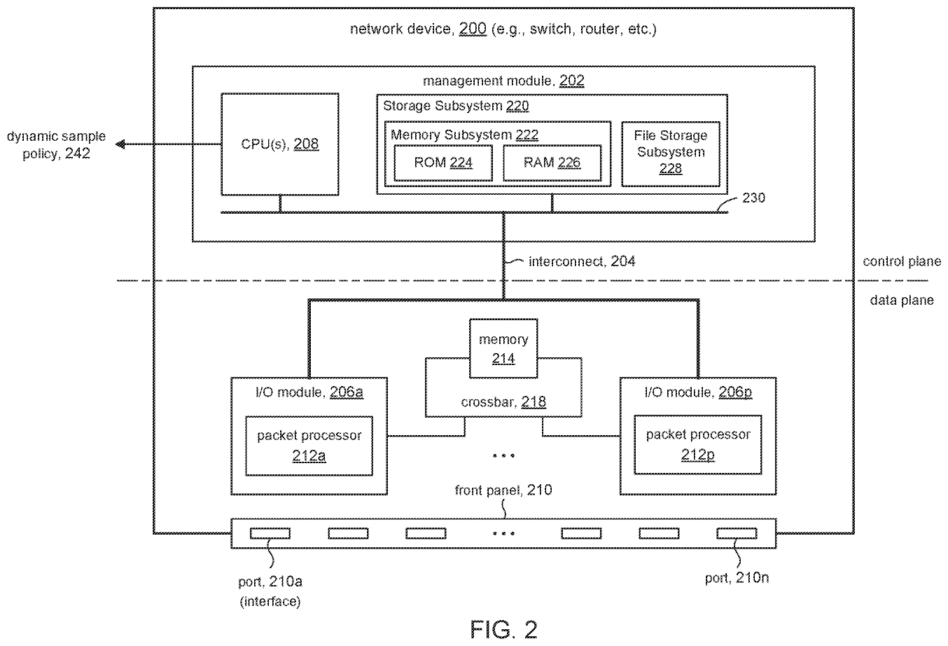

FIG. 2 is a high-level block diagram of a network device 200 (e.g., a router, switch, firewall, and the like) adapted in accordance with the present disclosure. In some embodiments, for example, network device 200 can include a management module 202, one or more I/O modules (switches, switch chips) 206a-206p, and a front panel 210 of I/O ports (physical interfaces, I/Fs) 210a-210n. Management module 202 can constitute the control plane of network device 200 (also referred to as the control layer or simply the central processing unit, CPU), and can include one or more CPUs 208 for managing and controlling operation of network device 200 in accordance with the present disclosure. Each CPU 208 can be a general-purpose processor, such as an Intel®/AMD® x86, ARM® microprocessor and the like, that operates under the control of software stored in a memory device/chips such as read-only memory (ROM) 224 or random-access memory (RAM) 226. The control plane provides services that include traffic management functions such as routing, security, load balancing, analysis, and the like, in addition to processing telemetry in accordance with the present disclosure.

The one or more CPUs 208 can communicate with storage subsystem 220 via bus subsystem 230. Other subsystems, such as a network interface subsystem (not shown in FIG. 2), may be on bus subsystem 230. Storage subsystem 220 can include memory subsystem 222 and file/disk storage subsystem 228. Memory subsystem 222 and file/disk storage subsystem 228 represent examples of non-transitory computer-readable storage devices that can store program code and/or data, which when executed by one or more CPUs 208, can cause one or more CPUs 208 to generate and distribute dynamic sample policy 242 in accordance with embodiments of the present disclosure.

Memory subsystem 222 can include a number of memories such as main RAM 226 (e.g., static RAM, dynamic RAM, etc.) for storage of instructions and data during program execution, and ROM 224 on which fixed instructions and data can be stored. File storage subsystem 228 can provide persistent (i.e., non-volatile) storage for program and data files, and can include storage technologies such as solid-state drive and/or other types of storage media known in the art.

CPUs 208 can run a network operating system stored in storage subsystem 220. A network operating system is a specialized operating system for network device 200. For example, the network operating system can be the Arista EOS® operating system, which is a fully programmable and highly modular, Linux-based network operating system developed and sold/licensed by Arista Networks, Inc. of Santa Clara, California. It is understood that other network operating systems may be used.

Bus subsystem 230 can provide a mechanism for the various components and subsystems of management module 202 to communicate with each other as intended. Although bus subsystem 230 is shown schematically as a single bus, alternative embodiments of the bus subsystem can utilize multiple buses.

The one or more I/O modules 206a-206p can be collectively referred to as the data plane of network device 200 (also referred to as the data layer, forwarding plane, etc.). Interconnect 204 represents interconnections between modules in the control plane and modules in the data plane. Interconnect 204 can be any suitable bus architecture such as Peripheral Component Interconnect Express (PCIe), System Management Bus (SMBus), Inter-Integrated Circuit (I2C), etc.

I/O modules 206a-206p can include respective packet processing hardware comprising packet processors 212a-212p (collectively 212) to provide packet processing and forwarding capability. Each I/O module 206a-206p can be further configured to communicate over one or more ports 210a-210n on the front panel 210 to receive and forward network traffic. Packet processors 212 can comprise hardware (circuitry), including for example, data processing hardware such as an application specific integrated circuit (ASIC), field programmable gate array (FPGA), processing unit, and the like, which can be configured to operate in accordance with the present disclosure. Packet processors 212 can include forwarding lookup hardware such as, for example but not limited to, content addressable memory such as ternary CAMs (TCAMs) and auxiliary memory such as static RAM (SRAM).

Memory hardware 214 can include buffers used for queueing packets. I/O modules 206a-206p can access memory hardware 214 via crossbar 218. It is noted that in other embodiments, the memory hardware 214 can be incorporated into each I/O module. The forwarding hardware in conjunction with the lookup hardware can provide wire speed decisions on how to process ingress packets and outgoing packets for egress. In accordance with some embodiments, some aspects of the present disclosure can be performed wholly within the data plane.

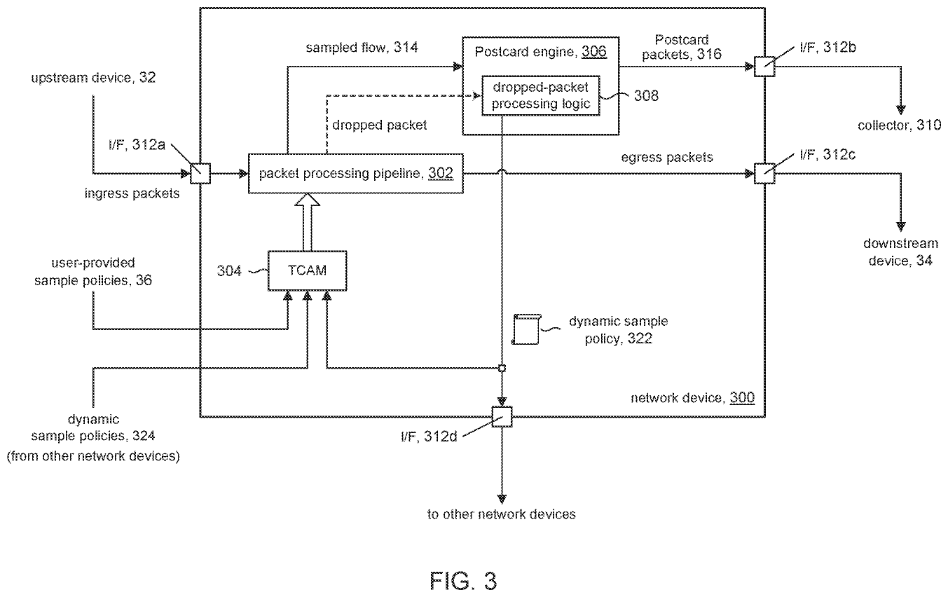

FIG. 3 is a high-level block diagram of circuitry (e.g., ASIC logic, FPGA firmware, TCAM hardware, etc.) in a network device for providing telemetry in accordance with various embodiments of the present disclosure. In some embodiments, for example, circuitry in network device 300 can include interface (I/F) circuits 312a-312d for receiving and transmitting data. A packet processing pipeline 302 can process ingress packets received on an I/F (e.g., 312a) from an upstream device 32 for egress on an I/F (e.g., 312c) to a downstream device 34. TCAM hardware 304 can store forwarding policies (rules) to support forwarding decisions made by packet processing pipeline 302.

The packet processing pipeline 302 can include logic to sample the ingress traffic to produce a sampled flow 314. In some embodiments, for example, the sampling can be based on sampling rules stored in TCAM hardware 304. The sampled flow 314 can be processed by Postcard engine 306 to produce Postcard packets 316 that can be transmitted to collector 310 via an I/F (e.g., 312b) on the network device 300. Sampling rules in TCAM 304 can come from user-defined sample policies 36; e.g., via network manager 104. In accordance with the present disclosure, sampling rules can come from a sample policy 322 generated by the network device 300 and/or from dynamic sample policies 324 generated by other network devices.

A network device may drop an ingress packet for various reasons. For example, TCAM 304 may be programmed with rules to intentionally drop certain packets, as in the case of security access control lists (ACLs) for instance. In a virtual local area network (VLAN) deployment, a packet may be dropped because the packet contains invalid VLAN tag(s). Packets may be dropped if a route to the destination cannot be determined, if ARP is unresolved for the destination IP, and so on. In accordance with some embodiments of the present disclosure, the packet processing pipeline 302 can be configured to signal the occurrence of a dropped packet to dropped-packet processing logic 308 in the Postcard engine 306

In accordance with the present disclosure, network device 300 can include dropped-packet processing logic 308 to process dropped packets. In some embodiments, for example, packet processing pipeline 302 can signal the dropped-packet processing logic 308 when the packet processing pipeline has marked or otherwise identified a packet to be dropped. The dropped packet can be provided to the dropped-packet processing logic 308.

In accordance with the present disclosure, the dropped-packet processing logic 308 can generate a dynamic sample policy 322 based on the dropped packet. The sample policy 322 is “dynamic” in that the policy is generated in response to the occurrence of a dropped packet. The sampling rules that constitute sample policy 322 can be programmed in TCAM hardware 304. In accordance with the present disclosure, the sample policy 322 can be distributed to other Postcard-enabled network devices; e.g., via I/F 312d. These aspects of the present disclosure are discussed in more detail below. Further in accordance with the present disclosure, the dropped-packet processing logic 308 can provide the dropped packet, received from the packet processing pipeline 302, to the Postcard engine processing logic to generate a Postcard packet containing the dropped packet for transmission to the collector 310.

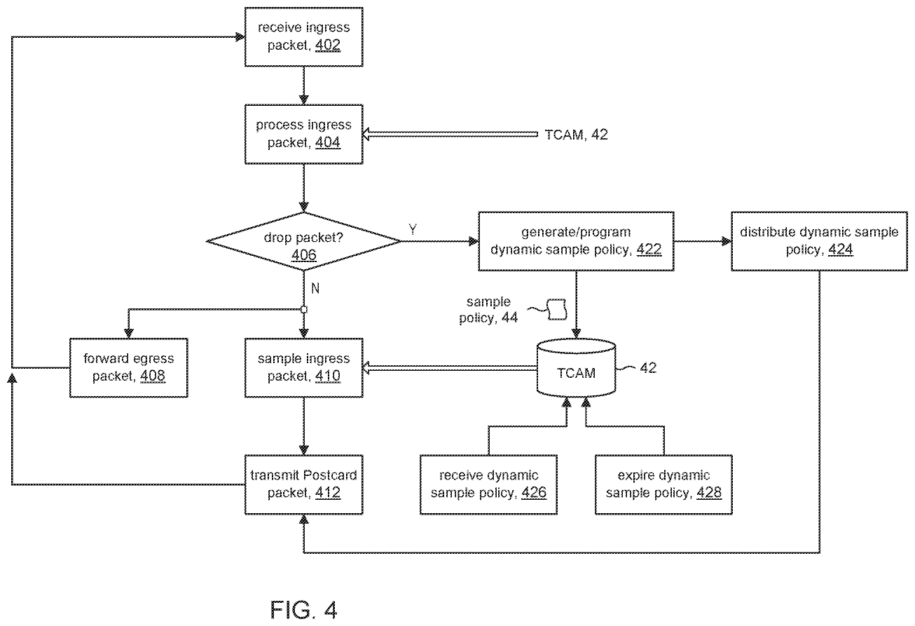

Referring to FIG. 4, the discussion will now turn to a high-level description of processing in a network device (e.g., 200, FIG. 2, 300, FIG. 3) for performing telemetry in accordance with the present disclosure. Depending on a given implementation, the processing may be performed entirely in the control plane or entirely in the data plane, or the processing may be divided between the control plane and the data plane. In some embodiments, the network device can include one or more processing units (circuits), which when operated, can cause the network device to perform processing in accordance with FIG. 4. Processing units (circuits) in the control plane, for example, can include general CPUs that operate by way of executing computer program code stored on a non-volatile computer readable storage medium (e.g., read-only memory); e.g., CPU 208 (FIG. 2) in the control plane can be a general CPU. Processing units (circuits) in the data plane can include specialized processors such as digital signal processors, field programmable gate arrays, application specific integrated circuits, and the like, that operate by way of executing computer program code or by way of logic circuits being configured for specific operations. For example, each of the packet processors 212a-212p in the data plane (FIG. 2) can be a specialized processor. The operation and processing blocks described below are not necessarily executed in the order shown. Operations can be combined or broken out into smaller operations in various embodiments. Operations can be allocated for execution among one or more concurrently executing processes and/or threads.

At operation 402, the network device can receive a (ingress) packet. The packet can come from any upstream device. In various instances, the upstream device can be a (source) host machine, another network device, and so on.

At operation 404, the network device can process the ingress packet to generate an outgoing egress packet. In various embodiments, this operation can be performed in a packet processing pipeline circuit (e.g., circuit 302 in FIG. 3). TCAM 42 can provide rules to facilitate the forwarding process.

At decision point 406, if the network device drops the ingress packet, then processing can proceed to operation 422. For example, the network device can drop the packet in response to a rule programmed in the TCAM 42. The network device can drop the packet if an error is detected in the packet, and so on. If the packet is not dropped, then processing can proceed to operations 408 and 410; otherwise processing can proceed to operation 422 to process dropped packets in accordance with the present disclosure (discussed below).

At operation 408, the network device can forward the egress packet generated at operation 404. Processing of the ingress packet can be deemed complete and processing can return to operation 402 to process the next ingress packet.

At operation 410, the network device can sample the ingress packet. For example, if the packet matches a sampling rule stored in TCAM 42, then the packet can be sampled (duplicated). The sampled packet can be processed at operation 412 to transmit the sampled packet to a collector. Processing of the ingress packet can be deemed complete and processing can return to operation 402 to process the next ingress packet.

At operation 412, the network device can transmit the sampled packet in a Postcard packet, for example, by a sampling engine such as Postcard engine 306 in FIG. 3. In some embodiments, the Postcard engine can generate a Postcard packet; e.g., the payload portion of the Postcard packet comprises the sampled packet and the header portion contains destination information (e.g., IP address) of a collector. It will be understood that in various embodiments, the Postcard packet can be transmitted to one or more collectors (e.g., 106). As shown in FIG. 1B, a Postcard packet may contain more than one sample. Accordingly, in some embodiments, the Postcard engine can aggregate multiple samples into one Postcard packet before transmitting the Postcard packet to the collector.

### Dropped Packet Processing

At operation 422, the network device can process a dropped packet by generating a dynamic sample policy 44 based on the dropped packet. The generated sample policy is “dynamic” in that the policy is dynamically generated in response to a dropped packet. The sample policy can comprise a rule for matching the dropped packet. In some embodiments, for example, a rule can comprise criteria that match the 5-tuple of the dropped packet. Suppose, for example, a dropped packet contained the following header information:
source IP: 192.100.200.10
source port: 12345
destination IP: 292.300.400.20
destination port: 56789
protocol type: tcp
   the following dynamic sample policy can be generated, comprising the following sampling rule:

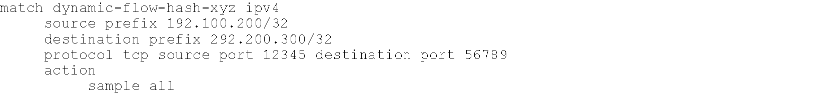

where dynamic-flow-hash-xyz represents a unique name for the dynamically generated sampling rule. For example, “xyz” can represent a hash value generated from a portion of the ingress packet (e.g., the header)
   source prefix, destination prefix, protocol, source port, and destination port are match criteria
   sample all is an action that instructs the network device to sample all packets that match the match criteria

The generated sample policy 44 can be programmed in TCAM 42 of the network device to capture subsequent packets in the flow that the dropped packet came from. In other words, the generated sample policy targets the flow that contains the dropped packet. Without the generated sample policy, sampling is random and there is no guarantee that packets in the targeted flow will get sampled with any predictability. Likewise, although a switch may drop a packet, the random nature of random sampling may not pick up the dropped packet for sampling and collection by the collector. The generated sample policy matches on all packets in the targeted flow to ensure that packets in the targeted flow will be explicitly sampled and sent to the collector.

It will be appreciated that in some embodiments, each interface on the network device can be associated with a dynamic sample policy. The dynamic sample policy associated with or applied to one interface can be different from the dynamic policy associated with another interface. The dynamic sample policy applied to a given one interface can comprise rules to match flows that were detected on that interface. For example, a dynamic policy 1 on interface Et1 may have rules to match for Flow 1 and Flow 2 because dropped packets were detected for Flow 1 and Flow 2. On the other hand, a dynamic policy 2 on interface Et2 may have rules for Flow 1, Flow 3, and Flow 4, because dropped packets were detected for Flows 1, 3, and 4 on Et2.

In some embodiments, rules for different flows may be coalesced if there was some overlap in the 5-tuples that define the flows. For example, if three flows have the same 5-tuples except for the source IP parameter, then a new rule can be defined that matches on the 4 parameters that are common to the 5-tuples. The new rule can replace the existing three rules, thus reclaiming TCAM storage.

At operation 424, the network device can distribute its generated sample policy 44 to other network devices (nodes) in the network, both upstream devices and downstream devices. In some embodiments, the network device can send the sample policy to a network manager (e.g. 104, FIG. 1A). The network manager can download the sample policy to other network devices in the network. An example of this operation is illustrated in FIG. 1A, where switch 2 generates a dynamic sample policy 112 that it transmits to network manager 104. Network manager 104 then distributes the sample policy 112 to switch 1 (upstream relative to switch 2 in the direction from Host 1 to Host 2) and switch 3 (downstream relative to switch 2 in the direction from Host 1 to Host 2). It will be appreciated that in other embodiments (not illustrated), the network device itself can send its generated sample policy 44 directly to other network devices. In some embodiments, for example, the network device can advertise the sample policy to other network devices in the network. Processing can proceed to operation 412 to generate and transmit a Postcard packet containing the dropped packet to a collector.

At operation 426, the network device can receive a dynamic sample policy generated by another network device operating in accordance with the present disclosure. In response, the network device can program the received sample policy into TCAM 42. Operations 424 and 426 ensure that a given flow that experiences a dropped packet will be sampled by all the network devices along the path of the given flow.

At operation 428, the network device can expire a previously programmed dynamic sample policy in TCAM 42 that it generated for a dropped packet. In some embodiments, for example, if a flow that was previously targeted for sampling has not exhibited any dropped packets for a predetermined (e.g., user-defined) period of time, then the network device can delete the corresponding sample policy in TCAM 42. The network device can communicate with the other network devices (directly or indirectly via the network controller) to delete their copies of the sample policy from their respective TCAMs. In some embodiments, the trigger to expire a previously programmed dynamic sample policy can originate from the network device that originally detected the packet drop.

In some embodiments, for example, the collector can monitor all the packets of the targeted flow it receives from the network devices on the path of the targeted flow. The collector can determine that the targeted flow is no longer experiencing drops. When the collector determines that targeted flow is no longer experiencing drops for a given period of time (say one minute), the targeted flow can be deemed to have recovered (e.g., no longer experiencing drops) and sampling is no longer needed. The collector can trigger the deletion of the sample policy from the network devices to avoid unnecessary sampling of network traffic. In some embodiments, a buffer time (say one minute) can be added before triggering the deletion of the sample policy to capture additional packets of the targeted flow to assess how the flow is likely to behave post-drop. In other words, the collector can delay for a period of time after the target flow is deemed to have recovered.

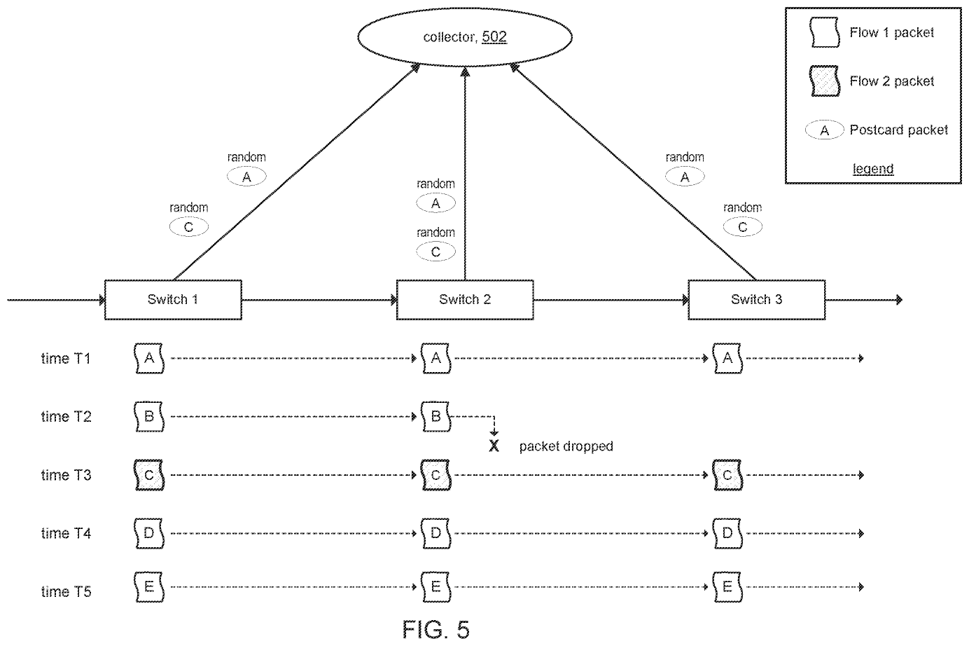

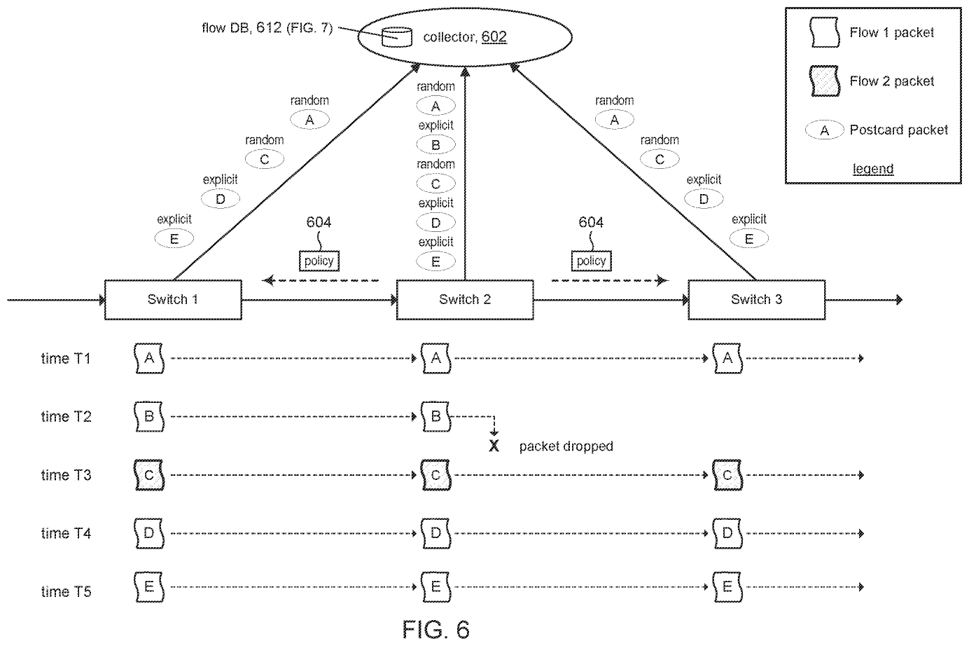

The discussion will turn to an example of the operations of FIG. 4. For comparison purposes, FIG. 5 illustrates an example of conventional prior art Postcard processing, while FIG. 6 illustrates an example of Postcard processing in accordance with some embodiments of the present disclosure.

The example configuration shown in FIG. 5 includes network devices Switch 1, Switch 2, and Switch 3, and collector 502. Each switch is configured for conventional Postcard Telemetry; in other words, each switch randomly samples its ingress packets. FIG. 5 shows a legend of symbols for Flow 1 packets, Flow 2 packets, and Postcard packets. Packets for Flow 1 can be identified by a 5-tuple and packets for Flow 2 can be identified by a different 5-tuple.

The following description explains packet processing by Switch 1, Switch 2, and Switch 3 at times T1-T5 in accordance with conventional Postcard processing. Assume for discussion purposes that packet A and packet C are randomly selected for sampling and that packet B is dropped:
time T1—Switch 1 receives a packet A in Flow 1, which is forwarded to Switch 2 and then to Switch 3. Because packet A is randomly selected for sampling (e.g., based on its TCP/UDP checksum), each switch generates a Postcard for packet A and transmits the Postcard to collector 502.
time T2—Switch 1 receives a packet B in Flow 1. The packet is not sampled and forwarded to Switch 2, which drops the packet.
time T3—Switch 1 receives a packet C in Flow 2, which is forwarded to Switch 2 and then to Switch 3. Because packet C is randomly selected for sampling (e.g., based on its TCP/UDP checksum), each switch generates a Postcard for packet C and transmits the Postcard to collector 502.
time T4—Switch 1 receives a packet D in Flow 1, which is forwarded to Switch 2 and then Switch 3 without being sampled.
time T5—Switch 1 receives a packet E in Flow 1, which is forwarded to Switch 2 and then Switch 3 without being sampled.

FIG. 5 illustrates, in conventional prior art sampling techniques, packets in a flow that experiences packet drops will not necessarily be sampled. In the example shown in FIG. 5, where packet B is not selected for sampling, the collector will not detect that packet B was dropped. However, if packet B were selected for sampling, then the collector 502 could detect that packet B was dropped by virtue of having received a sample from Switch A but not Switch B. Because of the random nature of sampling, we can see there is no guarantee that the collector will learn of dropped packets in a flow. In the example in FIG. 5, the collector 502 is not able to do any analysis on Flow 1 in response to experiencing a dropped packet because: (1) the collector does now know of the dropped packet to begin with; and (2) the collector does not have the complete flow information for Flow 1. In this example, packets D and E in Flow 1 were not sampled.

Referring to FIG. 6, operation in accordance with the flow of FIG. 4 will now be described with the example shown in FIG. 6. The configuration shown in FIG. 6 includes network devices Switch 1, Switch 2, and Switch 3, and collector 602. Each switch is configured to deliver Postcard packets to collector 602 in accordance with the present disclosure, although it will be appreciated that Postcard processing can be performed by equipment that operate in conjunction with the network switches.

FIG. 6 shows a legend of symbols for Flow 1 packets, Flow 2 packets, and Postcard packets. Packets for Flow 1 can be identified by a 5-tuple, and likewise packets for Flow 2 can be identified by a different 5-tuple.

The following description explains packet processing by Switch 1, Switch 2, and Switch 3 at times T1-T5 with references to operations in FIG. 4. As with FIG. 5, assume for discussion purposes that only packet A and packet C are randomly selected for sampling and that packet B is dropped:
time T1—Switch 1 receives packet A in Flow 1 (operation 402), which is forwarded to Switch 2 and then Switch 3 (operation 408). Because packet A is randomly selected for sampling (operation 410), each switch generates a Postcard for packet A and transmits the Postcard to collector 602 (operation 412).
time T2—Switch 1 receives packet B in Flow 1. The packet is not sampled and is forwarded to Switch 2 (operation 408). Switch 2 drops the packet (decision point 406).
Switch 2 generates a sample policy that is programmed in its TCAM (operation 422). The sample policy can comprise a rule that matches on Flow 1, for example, the rule may match on the 5-tuple of packet B.
Switch 2 distributes the generated sample policy 604 to Switches 1 and 3 (operation 424). The sample policy can be transmitted directly to Switches 1 and 3 by Switch 2, or the sample policy can be transmitted to a central controller (e.g. network manager) which then transmits to Switches 1 and 3.
Switch 2 generates a Postcard for the dropped packet B and transmits the Postcard to collector 602 (operation 412).
Switches 1 and 3 receive the sample policy, and they program the received sample policy in their respective TCAMs (operation 426).
time T3—Switch 1 receives a packet C in Flow 2, which is then forwarded to Switch 2 and Switch 3 (operation 408). Because packet C is randomly selected for sampling (operation 410), each switch generates a Postcard for packet C and transmits the Postcard to collector 602 (operation 412).
time T4—Switch 1 receives a packet D in Flow 1, which is forwarded to Switch 2 and then Switch 3 (operation 408). Although packet D has not been randomly selected for sampling, packet D is explicitly sampled in Switch 1 (operation 410) by virtue of sample policy 604 having been programmed in Switch 1 at time T2. Switch 1 generates a Postcard for packet D and transmits the Postcard to collector 602 (operation 412).
Packet D is also explicitly sampled in Switch 2 (operation 410) by virtue of sample policy 604 having been programmed in Switch 2 at time T2. Switch 2 generates a Postcard for packet D and transmits the Postcard to collector 602 (operation 412).
Likewise in Switch 3, packet D is explicitly sampled (operation 410) by virtue of sample policy 604 having been programmed in Switch 3 at time T2. Switch 3 generates a Postcard for packet D and transmits the Postcard to collector 602 (operation 412).
time T5—Switch 1 receives a packet E in Flow 1, which is then forwarded to Switch 2 and Switch 3 (operation 408). Although packet E has not been randomly selected for sampling, packet E is explicitly sampled in Switch 1 (operation 410) by virtue of sample policy 604 having been programmed in Switch 1 at time T2. Switch 1 generates a Postcard for packet E and transmits the Postcard to collector 602 (operation 412).
Packet E is also explicitly sampled in Switch 2 (operation 410) by virtue of sample policy 604 having been programmed in Switch 2 at time T2. Switch 2 generates a Postcard for packet E and transmits the Postcard to collector 602 (operation 412).
Likewise in Switch 3, packet E is explicitly sampled (operation 410) by virtue of sample policy 604 having been programmed in Switch 3 at time T2. Switch 3 generates a Postcard for packet E and transmits the Postcard to collector 602 (operation 412).

FIG. 6 illustrates the effect of a dropped packet, which is the generation of a sample policy that targets the flow experiencing the dropped packet. The generated sample policy causes all packets in the flow to be sampled, the flow is explicitly sampled. The generated sample policy is communicated or otherwise provided to upstream and downstream devices, causing those devices to explicitly sample the targeted flow.

Generating and programming a sample policy to match a flow that experiences one or more dropped packets ensures that all packets in the flow will be sampled in response to the occurrence of a packet drop. As illustrated in FIG. 6, for example, prior to the packet drop in Flow 1, packet A of Flow 1 was randomly sampled at Switch 1. In response to Switch 2 dropping packet B in Flow 1, the sample policy is generated and programmed in Switch 2 so that all subsequent packets in Flow 1 will be sampled. The sample policy serves to explicitly sample all packets in Flow 1 rather than leaving the sampling to chance.

Distributing a sample policy to upstream and downstream devices ensures that the collector 602 receives telemetry from all devices along the path the flow takes through the network. FIG. 6, for example, shows that sample policy 204 is not only programmed in Switch 2, where the packet drop occurred but is distributed to and programmed in Switches 1 and 3 so that the flow can be sampled by each switch it passes through.

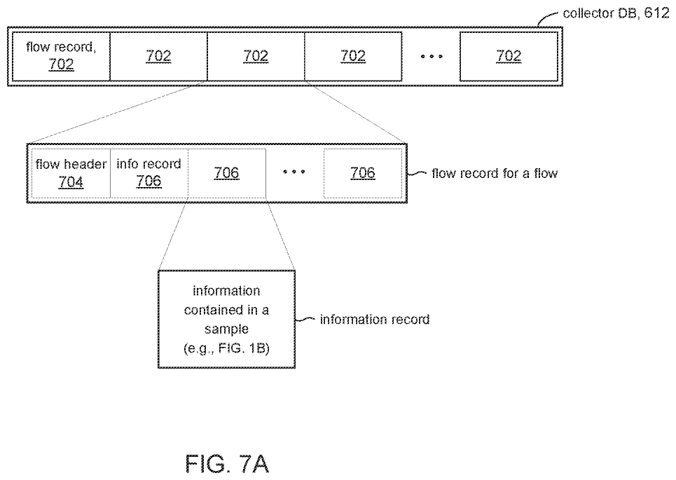

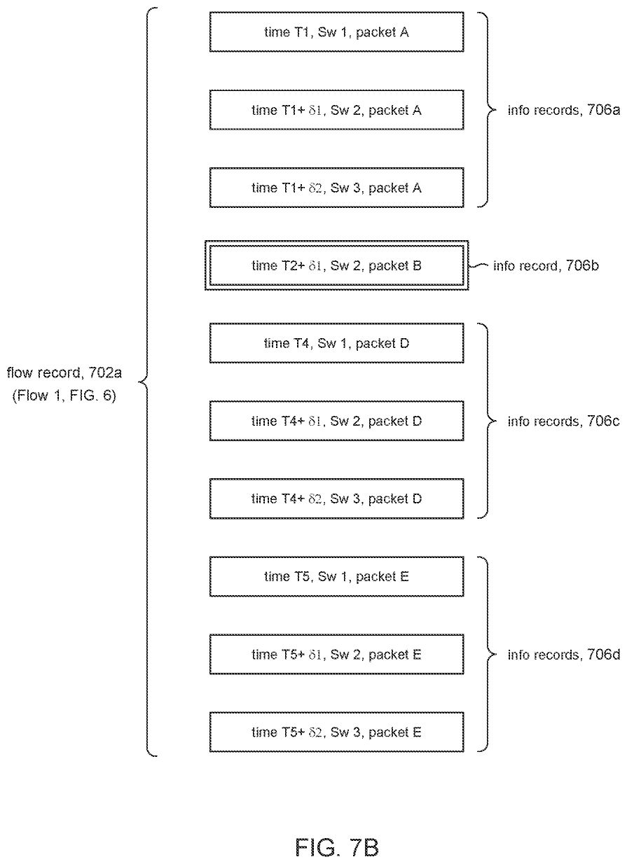

Referring to FIGS. 7A and 7B, the discussion will now turn to an example of how the collector 602 can maintain a collector database (DB) 612 for recording a flow that experiences a dropped packet. FIG. 7A shows an illustrative example of a format for the collector DB 612 in accordance with some embodiments. The DB 612 can comprise a plurality of flow records 702. Each flow record 702 is associated with a flow and stores information for packets sampled from that flow. Each flow record 702 comprises a flow header 704 and information records 706. The flow header 704 identifies the flow. For example, the flow can be identified based on the 5-tuple of the packets in the flow, although it will be appreciated that a flow can be identified based on information in addition to the 5-tuple or in place of the 5-tuple. Each information record 706 is associated with a sampled packet. A Postcard packet received by the collector 306 can generate an information record 706 for each sampled packet contained in the received Postcard packet. An information record 706 can include information contained in the sample header (FIG. 1B) of the sampled packet and information derived from previously received sampled packets.

FIG. 7B illustrates a snapshot (instance) of the flow record 702a for the example for Flow 1 depicted in FIG. 6. The flow record 702a comprises the following information records 706a-706d:
information records 706a—These records contain information in Postcards for randomly sampled packet A, received from Switch 1 at time T1, Switch 2 at time T1+81, and Switch 3 at time T1+82. The time increment 81 represents the transmission delay from Switch 1 to Switch 2, and likewise, time increment 82 represents the transmission delay from Switch 2 to Switch 3.
information record 706b—This record contains information contained in the Postcard packet B received by Switch 2 at time T2+81. Recall that packet B was not randomly selected, so there is no Postcard from Switch 1. However, in our example, the packet was dropped by Switch 2. In accordance with the present disclosure, packet B is reported to the collector. Further in accordance with the present disclosure, Switch 2 informs or otherwise notifies the other switches to explicitly sample the flow that contains packet B, namely Flow 1, so that going forward subsequent packets in Flow 1 will be explicitly sampled.
information records 706c—These records contain information in Postcards for explicitly sampled packet D, received from Switch 1 at time T4, Switch 2 at time T4+δ1, and Switch 3 at time T4+δ2. The packet is explicitly sampled in response to packet B being dropped by Switch 2.
information records 706d—These records contain information in Postcards for explicitly sampled packet E, received from Switch 1 at time T5, Switch 2 at time T5+δ1, and Switch 3 at time T5+δ2. The packet is explicitly sampled in response to packet B being dropped by Switch 2.

### Further Examples

Features described above as well as those claimed below may be combined in various ways without departing from the scope hereof. The following examples illustrate some possible, non-limiting combinations:

(A1) A method in a network device for sampling traffic flows, the method comprising: receiving ingress data traffic, wherein the ingress data traffic comprises a plurality of flows; dropping a data packet in the ingress data traffic; in response to dropping the data packet in the ingress data traffic, generating one or more sampling rules whose match criteria match packets of a flow (“targeted flow”) that contains the dropped data packet; programming the one or more sampling rules in a memory of the network device; sampling ingress data traffic received subsequent to the programming using the one or more sampling rules to obtain samples of data packets contained in the targeted flow; and reporting the samples of data packets to at least one collector.

(A2) For the method denoted as (A1), prior to the network device dropping the dropped data packet, data packets in the targeted flow were at most randomly sampled.

(A3) The method denoted as any of (A1) through (A2), further comprising deleting the one or more sampling rules at a time when the targeted flow is deemed to be no longer experiencing dropped packets.

(A4) For the method denoted as any of (A1) through (A3), the targeted flow is deemed to be no longer experiencing dropped packets when the targeted flow has not exhibited a packet drop for a predetermined period of time.

(A5) The method denoted as any of (A1) through (A4), further comprising, before deleting the one or more sampling rules, delaying for a period of time after a point in time that the targeted flow is deemed to be no longer experiencing dropped packets.

(A6) The method denoted as any of (A1) through (A5), further comprising distributing the one or more sampling rules to other network devices in the network, wherein the other network devices sample their respective ingress data traffic using the one or more sampling rules to identify data packets in the targeted flow and report on their respective identified data packets to the collector.

(A7) For the method denoted as any of (A1) through (A6), distributing the one or more sampling rules includes sending the one or more sampling rules to a network management system, wherein the network management system distributes the one or more sampling rules to the other network devices.

(A8) For the method denoted as any of (A1) through (A7), distributing the one or more sampling rules includes the network device sending the one or more sampling rules to the other network devices in the network.

(A9) For the method denoted as any of (A1) through (A8), the one or more sampling rules are distributed to network devices on a path of the targeted flow.

(A10) For the method denoted as any of (A1) through (A9), reporting the samples of data packets includes generating Postcard Telemetry packets that comprise the samples of data packets.

(B1) A network device comprising: one or more computer processors; a memory; and a computer-readable storage device comprising instructions for controlling the one or more computer processors to: receive ingress data traffic, wherein the ingress data traffic comprises a plurality of flows; drop a data packet in the ingress data traffic; subsequent to the dropped data packet, trigger sampling a flow (“targeted flow”) that contains the dropped data packet, wherein all data packets of the targeted flow are sampled; and transmit the sampled data packets of the targeted flow to at least one collector.

(B2) For the network device denoted as (B1), the computer-readable storage device further comprises instructions for controlling the one or more computer processors to: generate one or more sampling rules that match on data packets of the targeted flow in response to the dropped data packet; and program the one or more sampling rules in the memory of the network device to sample the data packets of the targeted flow.

(B3) For the network device denoted as any of (B1) through (B2), the computer-readable storage device further comprises instructions for controlling the one or more computer processors to distribute the one or more sampling rules to other network devices in a data network, wherein network devices on a path of the targeted flow sample the data packets of the targeted flow and transmit the sampled data packets to the at least one collector.

(B4) For the network device denoted as any of (B1) through (B3), the computer-readable storage device further comprises instructions for controlling the one or more computer processors to send the one or more sampling rules to a network management system, wherein the network management system distributes the one or more sampling rules to the other network devices in a data network.

(B5) For the network device denoted as any of (B1) through (B4), the computer-readable storage device further comprises instructions for controlling the one or more computer processors to send the one or more sampling rules to the other network devices in a data network.

(B6) For the network device denoted as any of (B1) through (B5), the computer-readable storage device further comprises instructions for controlling the one or more computer processors to terminate sampling the targeted flow when the targeted flow no longer experiences packet drops for a predetermined period of time.

(B7) For the network device denoted as any of (B1) through (B6), the computer-readable storage device further comprises instructions for controlling the one or more computer processors to report the samples of data packets by generating Postcard Telemetry packets that comprise the samples of data packets.

(C1) A non-transitory computer-readable storage device in a network device having stored thereon computer executable instructions, which when executed, cause the network device to: receive ingress data traffic, wherein the ingress data traffic comprises a plurality of flows; drop a data packet in the ingress data traffic; subsequent to the dropped data packet, trigger sampling a flow (“targeted flow”) that contains the dropped data packet, wherein all data packets of the targeted flow are sampled; and transmit the sampled data packets of the targeted flow to at least one collector.

(C2) For the non-transitory computer-readable storage device denoted as (C1), the computer executable instructions, which when executed, further cause the network device to: generate one or more sampling rules that match on data packets of the targeted flow in response to the dropped data packet; and program the one or more sampling rules in a memory of the network device to sample the data packets of the targeted flow.

(C3) For the non-transitory computer-readable storage device denoted as any of (C1) through (C2), the computer executable instructions, which when executed, further cause the network device to distribute the one or more sampling rules to other network devices in a data network, wherein network devices on a path of the targeted flow sample the data packets of the targeted flow and transmit the sampled data packets to the collector.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents may be employed without departing from the scope of the disclosure as defined by the claims.

1. A method in a network device for sampling traffic flows, the method comprising:
receiving ingress data traffic, wherein the ingress data traffic comprises a plurality of flows;
dropping a data packet in the ingress data traffic;
in response to dropping the data packet in the ingress data traffic, generating one or more sampling rules whose match criteria match packets of a flow (“targeted flow”) that contains the dropped data packet;
programming the one or more sampling rules in a memory of the network device;
sampling ingress data traffic received subsequent to the programming using the one or more sampling rules to obtain samples of data packets contained in the targeted flow; and
reporting the samples of data packets to at least one collector.

2. The method of claim 1, wherein prior to the network device dropping the dropped data packet, data packets in the targeted flow were at most randomly sampled.

3. The method of claim 1, further comprising deleting the one or more sampling rules at a time when the targeted flow is deemed to be no longer experiencing dropped packets.

4. The method of claim 3, wherein the targeted flow is deemed to be no longer experiencing dropped packets when the targeted flow has not exhibited a packet drop for a predetermined period of time.

5. The method of claim 3, further comprising, before deleting the one or more sampling rules, delaying for a period of time after a point in time that the targeted flow is deemed to be no longer experiencing dropped packets.

6. The method of claim 1, further comprising distributing the one or more sampling rules to other network devices in the network, wherein the other network devices sample their respective ingress data traffic using the one or more sampling rules to identify data packets in the targeted flow and report on their respective identified data packets to the collector.

7. The method of claim 6, wherein distributing the one or more sampling rules includes sending the one or more sampling rules to a network management system, wherein the network management system distributes the one or more sampling rules to the other network devices.

8. The method of claim 6, wherein distributing the one or more sampling rules includes the network device sending the one or more sampling rules to the other network devices in the network.

9. The method of claim 6, wherein the one or more sampling rules are distributed to network devices on a path of the targeted flow.

10. The method of claim 1, wherein reporting the samples of data packets includes generating Postcard Telemetry packets that comprise the samples of data packets.

11. A network device comprising:
one or more computer processors;
a memory; and
a computer-readable storage device comprising instructions for controlling the one or more computer processors to:
receive ingress data traffic, wherein the ingress data traffic comprises a plurality of flows;
drop a data packet in the ingress data traffic;
subsequent to the dropped data packet, trigger sampling a flow (“targeted flow”) that contains the dropped data packet, wherein all data packets of the targeted flow are sampled; and
transmit the sampled data packets of the targeted flow to at least one collector.

12. The network device of claim 11, wherein the computer-readable storage device further comprises instructions for controlling the one or more computer processors to:
generate one or more sampling rules that match on data packets of the targeted flow in response to the dropped data packet; and
program the one or more sampling rules in the memory of the network device to sample the data packets of the targeted flow.

13. The network device of claim 12, wherein the computer-readable storage device further comprises instructions for controlling the one or more computer processors to distribute the one or more sampling rules to other network devices in a data network, wherein network devices on a path of the targeted flow sample the data packets of the targeted flow and transmit the sampled data packets to the at least one collector.

14. The network device of claim 12, wherein the computer-readable storage device further comprises instructions for controlling the one or more computer processors to send the one or more sampling rules to a network management system, wherein the network management system distributes the one or more sampling rules to the other network devices in a data network.

15. The network device of claim 12, wherein the computer-readable storage device further comprises instructions for controlling the one or more computer processors to send the one or more sampling rules to the other network devices in a data network.

16. The network device of claim 11, wherein the computer-readable storage device further comprises instructions for controlling the one or more computer processors to terminate sampling the targeted flow when the targeted flow no longer experiences packet drops for a predetermined period of time.

17. The network device of claim 11, wherein the computer-readable storage device further comprises instructions for controlling the one or more computer processors to report the samples of data packets by generating Postcard Telemetry packets that comprise the samples of data packets.

18. A non-transitory computer-readable storage device in a network device, the non-transitory computer-readable storage device having stored thereon computer executable instructions, which when executed, cause the network device to:
receive ingress data traffic, wherein the ingress data traffic comprises a plurality of flows;
drop a data packet in the ingress data traffic;
subsequent to the dropped data packet, trigger sampling a flow (“targeted flow”) that contains the dropped data packet, wherein all data packets of the targeted flow are sampled; and
transmit the sampled data packets of the targeted flow to at least one collector.

19. The non-transitory computer-readable storage device of claim 18, wherein the computer executable instructions, which when executed, further cause the network device to:
generate one or more sampling rules that match on data packets of the targeted flow in response to the dropped data packet; and
program the one or more sampling rules in a memory of the network device to sample the data packets of the targeted flow.

20. The non-transitory computer-readable storage device of claim 18, wherein the computer executable instructions, which when executed, further cause the network device to distribute the one or more sampling rules to other network devices in a data network, wherein network devices on a path of the targeted flow sample the data packets of the targeted flow and transmit the sampled data packets to the collector.
